(19) United States
(12) Patent Application Publication
(10) Pub. No.: US 2008/0045343 A1
(43) Pub. Date: Feb. 21, 2008

(54) SYSTEM AND METHOD FOR PLAYING CHESS WITH THREE OR MORE ARMIES OVER A NETWORK

(76) Inventor: HERMINA SAUBERMAN, PASO ROBLES, CA (US)

Correspondence Address: ADVANTIA LAW GROUP, 9035 SOUTH 1300 EAST, SUITE 200, SANDY, UT, 84094, US

(21) Appl. No.: 11/747,612

(22) Filed: May 11, 2007

Related U.S. Application Data
(60) Provisional application No. 60/747,055, filed on May 11, 2006.

(51) Int. Cl. G06F 17/00; A63F 13/00

(52) U.S. Cl. 463/42; 273/261

(57) ABSTRACT

A system and method for playing chess with three or more armies over a network comprising the steps of: generating a graphical user interface, according to a first mode, including: a virtual gameboard including a plurality of substantially square-shaped playing spaces; a first, second and third army; wherein the first army, the second army, and the third army are associated with the plurality of substantially square-shaped playing spaces; providing control of the first, second, and third armies to one or more players over a network; forming an alliance according to a second mode among players. The system and method further comprise altering the rule of game play upon the formation of an alliance between the first player and the second player.

### CROSS-REFERENCE TO RELATED APPLICATIONS

This invention claims priority, under 35 U.S.C. § 120, to the U.S. Provisional Patent Application No. 60/747,055 filed on May 11, 2006, which is incorporated by reference herein.

### BACKGROUND OF THE INVENTION

1. Field of the Invention

The present invention relates to systems and methods for playing chess, specifically to systems and methods for playing chess with three or more armies over a network.

2. Description of the Related Art

Once limited to being the pastime of royalty only, chess is now deeply rooted in the culture of every country in the world and every social station of life. It has endured not only because it has highly beneficial lessons to teach us (not the least of which is humility) but also because it is so enjoyable. It endures as a robust, language-independent bridge that transcends and connects all cultures.

This dynamic art form has demonstrated tremendous adaptability to change over the course of 1400 years and still maintain its appeal and the integrity of the original idea as a battle between armies of individuals and allies in mental combat. Society, culture, technology, and battlefield encounters are global now, and chess again morphs to adapt.

When first developed, chess represented the tribal warfare style of its Indian originators: two allied armies opposing two other allies. As Europe adopted the game, the four armies were merged into two. Chess battles were fought the way battles were fought in medieval Europe: two lines (armies) facing each other across the field. Wars were fought like this until the Korean War.

Vietnam changed the rules of battle. Beginning with Vietnam, battles have been fought not as broad lines but as one-on-one skirmishes, using surprise and lightning strikes as weapons, along with formation of temporary alliances with people who later end up as opponents. In Vietnam, the enemy did not face you, he surrounded you. Battles were guerilla-style attacks.

Battleground reality is morphing into new forms, with increasing reliance on political force and emphasis on tactics of opportunity rather than longer-term strategy. The battleground is global, the enemy is everywhere, and from the “get-go,” participants are surrounded by multiple opponents determined to defeat them.

Four player variations of Chess began to emerge that reflects this new social value of chess. Chess evolved from being strictly a gentleman's game into a pastime for general society. The first four-handed version of chess on an extended chessboard (called the Hughes variation) was published in Frere's Hand Book in 1958. This four-army chess game had three ranks added to a standard chessboard, with two opposing Queens on white, the other two on black.

In the past two decades, with introduction computer and network technology, chess has become increasingly available to more persons, and the ability for more people to play against a variety of opponents of different skill levels has increased dramatically. The development of three or more army chess has grown, however, the presence of a three or more army chess playable on a network is lacking. Some examples include but are not limited to the references described below, which references are incorporated by reference herein:

U.S. Pat. No. 3,843,130, issued to Whitney, discloses a basic playing area of 64 playing squares arranged in eight bilaterally alternately colored rows having eight playing squares per row. The checkerboard of the game has three additional such rows on each side of the basic playing area, the innermost of which carry the pawns, the intermediate of which carry the conventional royalty pieces, and the outermost of which consist of two playing squares apiece that are coextensive with the middlemost squares of the intermediate rows, and carry two additional royalty pieces selected from the group consisting of queens, knights, bishops and castles.

U.S. Pat. No. 5,125,666, issued to Adams, discloses a four-player chess game including a plurality of distinguishable sets of playing pieces including pieces equivalent to pawns, rooks, knights, bishops, queens and kings. It also includes a board having a main playing area made from a square matrix of eight-by-eight alternately colored playing spaces with two additional rows of eight alternately colored playing spaces adjacent each side of the main playing area. The game is played by placing each player's set of playing pieces on the game board so that each different set occupies two rows adjacent one side of the main playing area in a conventional chess arrangement. Each player moves, in turn, one of his playing pieces anywhere on the game board according to standard chess rules, except the pieces equivalent to pawns may move up to three spaces forward on each of those pieces' initial move. Playing pieces are captured according to standard chess rules, except the pieces equivalent to pawns initially located at the ends of the first additional rows of alternately colored playing spaces adjacent the main playing area may not move diagonally to capture another piece equivalent to a pawn that has not moved. When more than two players are playing and remain in the game, players are eliminated when their king is captured and actually removed from the board, at which time all the remaining playing pieces in the set of the removed king are taken off the board. Play continues until only two players remain, at which time the game ends when one player checkmates the other player's king or when neither player can checkmate the other player's king.

U.S. Pat. No. 6,142,474, issued to Tachkov, discloses a modified game of chess comprising four individual armies is disclosed herein. There can be two, three, or four individual participants. A gameboard is modified to comprise seventy-two alternating smaller squares of equal dimensions for a total of 144 squares, but of two distinct alternating colors. The gameboard has a border with linear groups of designation marks for initial pawn movements. The methodology is novel in that two, three, or four participants, each initially with his or her own modified army of chess pieces, can form or dissolve alliances with other armies. Armies may also, by checkmate, control one or more defeated armies. The result is a modified game for experienced players.

U.S. Pat. No. 4,147,360, issued to Bailey, et al, discloses a new chess game device and method for playing, for example, modified chess for four players. The novel chess game device includes a playing board of 260 squares using a set of twenty playing pieces consisting of 10 pawns and 10 other pieces per player for two, three or four players. Each set of playing pieces is colored in a distinct, separate color so that a different color is used to identify the playing pieces of each participant. The playing board is colored in the same four colors as the playing pieces in an alternating color fashion. The set of playing pieces of the novel chess game device includes all of the conventional chess pieces and two additional pieces called the Prime Minister and the Squire respectively. The Prime Minister's sphere of movement is the same as a conventional Queen except the Prime Minister may also move a single square at a right angle in either direction to its chosen course either before it starts movement on its chosen course or after it completes all movement on its chosen course. The Squire's sphere of movement is the same as a conventional Queen except it is limited to a movement of two squares in any direction that a conventional Queen can move. The method of playing the new game of chess is to use normal chess rules except as modified to utilize the larger board, the extra players, and an accelerated game to permit use by four people.

The inventions heretofore known suffer from a number of disadvantages which include: not enough gameboard space; inability to control tempo of gameplay; inability to bring together players of similar skills;

What is needed is a system and method for playing chess with three or more armies over a network that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available systems and method for playing chess with three or more armies. Accordingly, the present invention has been developed to provide a system and method which enable a chess game using three or more armies to be played over a network.

In one embodiment, there is a method and/or computer readable storage medium comprising computer readable program code for playing chess with three or more armies over a network, each army including a set of game pieces representative of game pieces of a chess game and configured to execute on a processor, the program code including instructions for generating a graphical user interface according to a first mode. The graphical user interface may include: a virtual gameboard including a plurality of substantially square-shaped playing spaces; a first army; a second army; and/or a third army; wherein the first army, the second army, and the third army are associated with the plurality of substantially square-shaped playing spaces. The method and/or readable program code may further comprise: providing control of the first army to a first player over a network; providing control of the second army to a second player over a network; providing control of the third army to a third player over a network; and/or forming an alliance according to a second mode, between the first player and the second player. In another embodiment, the method and/or readable program code may further comprise communicating data in a second mode between the first player and the second player through a closed channel to the exclusion of the third player and/or altering the rule of game play upon the formation of an alliance between the first player and the second player. Additionally, altering the rule of game play may be selected from the group consisting essentially of: preventing capture of the game pieces between the first and the second player, preventing enforcement of check rules between the first and the second player, preventing the first player from checkmating the second player and vice versa, and any combinations thereof.

In yet another embodiment, there is a system for playing chess with three or more armies over a network, each army including a set of game pieces representative of game pieces of a chess game. The system may comprise: a network module configured to communicate data over a network; a control module in communication with the network module; a graphical user interface module in communication with the control module, and/or configured to interface with a user. The graphical user interface module may comprise instructions for: generating a virtual gameboard, the virtual gameboard including a plurality of substantially square-shaped playing spaces; displaying a first army, a second army, and/or a third army, wherein the first army, the second army, and/or the third army are associated with the plurality of substantially square-shaped playing spaces. The system may further comprise: a first player module in communication with the graphical user interface module and/or including instructions for controlling the first army; a second player module in communication with the graphical user interface module and/or including instructions for controlling the second army; a third player module in communication with the graphical user interface module and/or including instructions for controlling the third army; and/or an alliance formation module in communication with the graphical user interface module, and/or configured to enable alliance formation between the first player module and/or the second player module.

In still another embodiment, the system for playing chess with three or more armies over a network may comprise an alliance formation module including instructions for altering a rule of game play upon formation of an alliance between the first player module and the second player module. Additionally, altering a rule of game play may be selected from the group consisting essentially of: preventing capture of the game pieces between the first and/or the second player, preventing enforcement of check rules between the first and/or the second player, preventing the first player from checkmating the second player and/or vice versa, communicating data between the first player module and/or the second player module through a closed channel to the exclusion of the third player module, and/or any combinations thereof.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). Understanding that these drawing(s) depict only typical embodiments of the invention and are not therefore to be considered to be limiting of its scope, the invention will be described and explained with additional specificity and detail through the use of the accompanying drawing(s), in which:

FIG. 1 is a module diagram of a system for playing chess with three or more armies over a network, according to one embodiment of the invention;

FIG. 2 is a flowchart illustrating a method for playing chess with three or more armies over a network, according to one embodiment of the invention;

FIG. 3 is a flowchart illustrating a method for playing chess with three or more armies over a network, according to one embodiment of the invention;

FIG. 4 is a flowchart illustrating a method for playing chess with three or more armies over a network, according to one embodiment of the invention;

FIG. 5 illustrates a graphical display, according to one embodiment of the invention;

FIG. 6 is a block diagram of a system for playing chess with three or more armies over a network, according to one embodiment of the invention; and

FIG. 7 is a block diagram of a system for playing chess with three or more armies over a network, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows NT, 95/98/2000, Vista, OS2, UNIX, Linux, Solaris, MacOS, etc.) as well as various conventional support software and drivers typically associated with computers. The computers may be in a home or business environment with access to a network. An embodiment of the invention may operate on a game console, such as those produced by Nintendo, Microsoft, and/or Sony. In an exemplary embodiment, access is through the Internet through a commercially-available web-browser software package.

As set forth in the specification, the system and method of the invention may facilitate the providing information to participants through multiple media sources and may allow one or more modules to receive information via similar multiple media sources. The multiple media sources may include, for example, chat room, radio, bulletin board, internet web pages, email, billboards, newsletters, commercials and/or the like. The present invention may be described herein in terms of functional block components, screen shots, optional selections and various processing steps. It should be appreciated that such functional blocks may be realized by any number of hardware and/or software components configured to perform the specified functions.

For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, C-Sharp, AJAX, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like.

Additionally, many of the functional units and/or modules herein are described as being “in communication” with other functional units and/or modules. Being “in communication” refers to any manner and/or way in which functional units and/or modules, such as but not limited to, computers, laptop computers, PDAs, modules, and other types of hardware and/or software, may be in communication with each other. Some non-limiting examples include communicating, sending, and/or receiving data and/or metadata via: a network, a wireless network, software, instructions, circuitry, phone lines, internet lines, carrier signals, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, AppleTalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

The multiplayer chess system and method were designed to extend the strategy challenges and thrill of winning. For example, armies and an additional turn as a booty of war are inherited by victors instead of the defeated army just being removed from the board. Rewards of checkmate are increased, and strategic and tactical challenges of checkmating are multiplied.

To add a greater opportunity for challenge, checkmate by team was added into the game. Two players coordinating to checks mate in a team environment offered an intriguing challenge not possible in chess. It also brought in another way to enjoy chess previously impossible: cooperation of opponents.

The multiplayer chess system and method, or quadra chess is designed to be entertaining and fun. Emphasis in QuadraChess is on fun and the social interaction of players. Unexpected possibilities and surprising situations arising from alliances are an important part of QuadraChess because they add such a great social dimension—they are the heart and soul of QuadraChess.

It offers these choices to two couples: do you partner up as men against women, or, do you partner up with your wife or your neighbor's wife? These are social issues that come up in four-play.

CHESS AS A SOCIAL AND FAMILY GAME QuadraChess was designed to open the game of chess to be a family game for the whole family to play together (now mom and dad can gang up on the kids.)

EASILY PLAYABLE Finally, one of the guiding principles of development of QuadraChess was to make it easily playable by anyone of any age who plays chess. It was invented as a means for more people to enjoy playing chess at one time—and has turned out to be so much more.

IT'S A PLAYER'S GAME. As you play QuadraChess, we are certain you will come up with your own variations and rules. We encourage you to do this. No rule may contradict a chess rule.

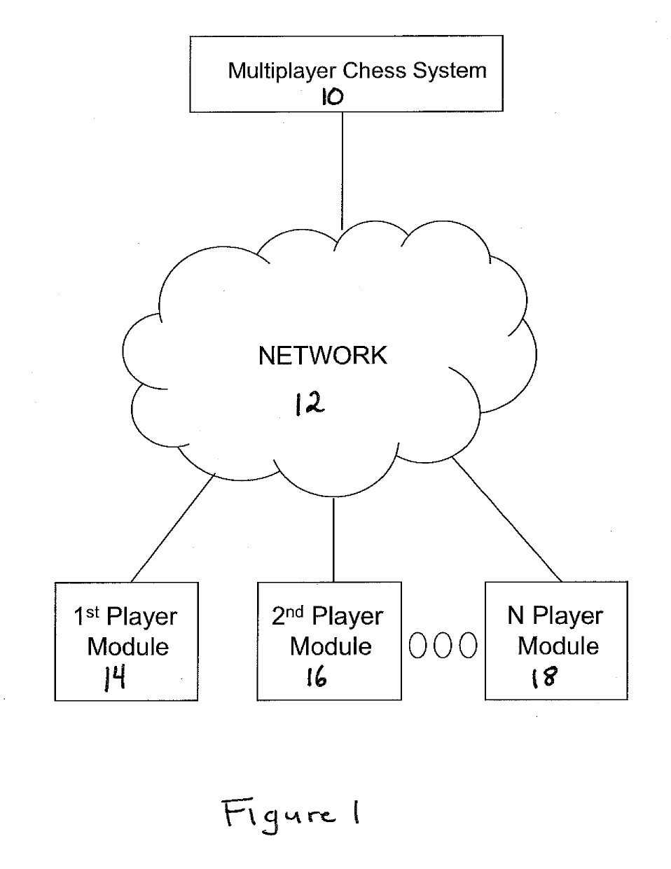

FIG. 1 illustrates an embodiment of the system 10 and method for playing chess with three armies over a network 12. There is shown a multiplayer chess system 10 in communication with a network 12, and a first player module 14, a second player module 16, and a N player module 18 in communication with the multiplayer chess system 10 via a network.

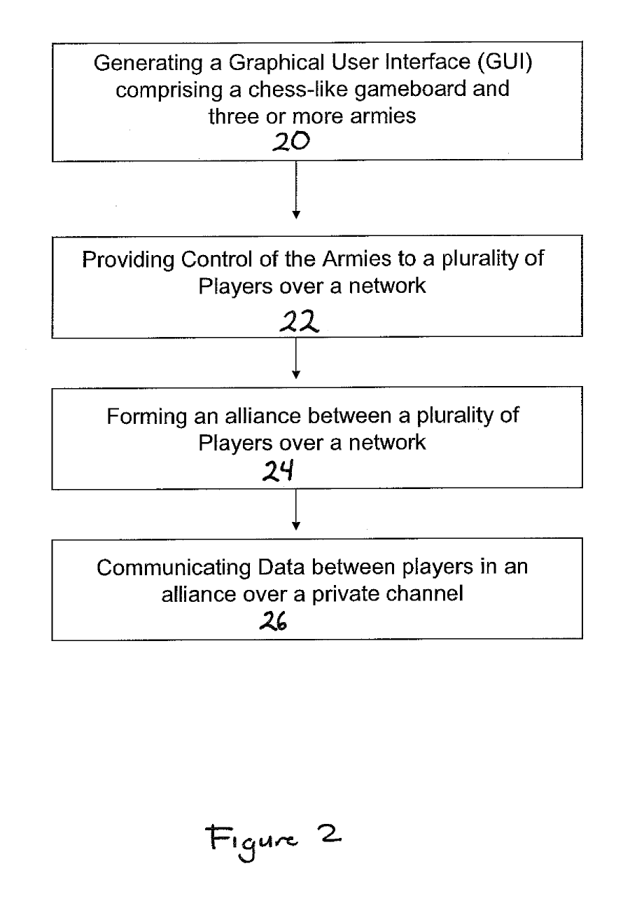

FIG. 2 illustrates a method for playing chess with three or more armies over a network, each army including a set of game pieces representative of game pieces of a chess game. The method includes the steps of: generating 20 a graphical user interface, or GUI) comprising a chess-like gameboard and three or more armies; providing 22 control of the armies to a plurality of players over a network; forming 24 an alliance between a plurality of player over a network; and communicating 26 data between the first player and the second player.

In one embodiment, providing control of the armies to a plurality of players over a network may include providing control over the armies among the player in any configuration contemplated in the art. Some non-limiting examples include: providing joint control over one army to more than one player, providing control of two or more armies to one player, and/or so forth. Additionally, the method may include transferring control of one or more armies or several pieces of the armies among the one more players upon satisfaction of a condition. The condition the condition may be selected from the group consisting essentially of: checkmate of the first player by the second player, resignation of the first player to the second player, an alliance formation between the first player and the second player, and any combinations thereof. In a non-limiting example, control of an army may be transferred from a defeated player to the player who to the victor or the play who just defeated. In an additional embodiment, once control of one of the armies is passed and/or transferred to one or more other player modules, the turn associated with that army is passed and/or transferred to those one or more other player modules.

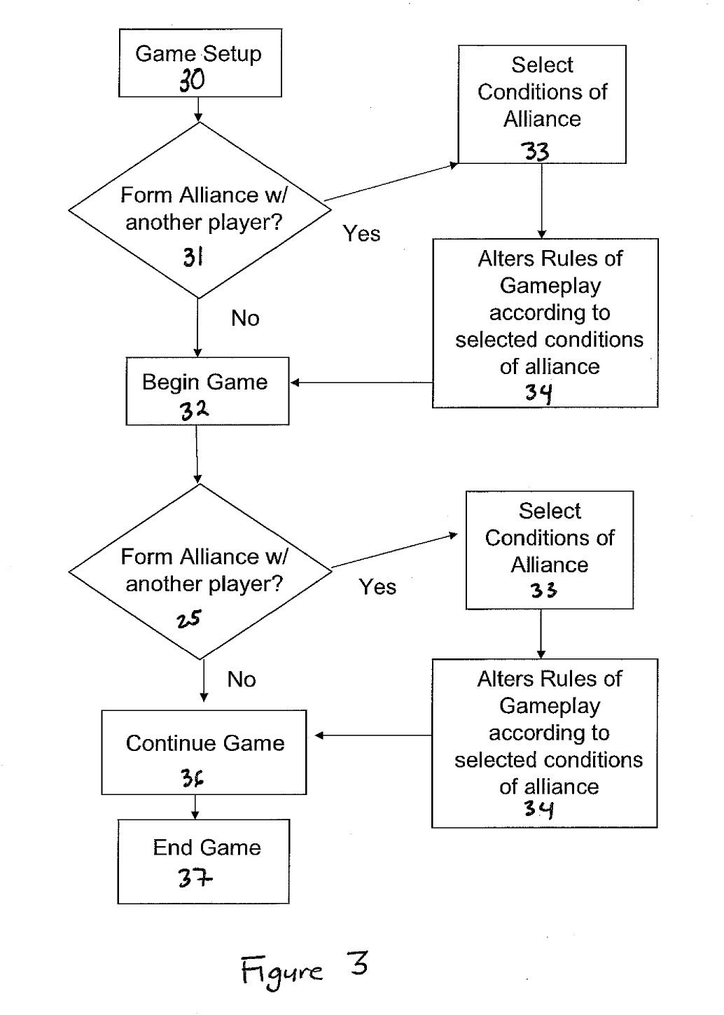

As shown in FIG. 3, the method may further include: setting up and/or configuring 30 the game setting; forming 31 alliances with other players in the game; if an alliance is selected then selecting 33 and/or configuring 33 the conditions of the alliance; altering 34 the rules of gameplay according to the selected conditions of the alliance; then beginning 32 the game. Alternatively, if an alliance is not selected, as shown, the game can then begin.

In an additional embodiment, the method includes communicating data in a second mode between the first player and the second player through a closed channel to the exclusion of the third player. Communicating data, conversing, send messages in between the first and second player through a closed, private channel advantageously provides enhancement to forming an alliance, as players of an alliance may chat, or blog privately without other players being able to see strategy. Communicating data, conversing, send messages in between the first and second player through a closed, private channel may be accomplished in any manner contemplated in the art or as taught in U.S. Patent Publication Nos. 2006/0284744 and 2006/0026233, which are incorporated by reference herein.

Additionally as shown in FIG. 3, after the game has begun and/or while the game is being played, one or more players may choose to form 31 an alliance with another player. If an alliance is formed during play, the game may or may not be paused while conditions are selected 33 and/or configured 33 to govern the alliance. The rules of gameplay are then altered 34 according to the selected conditions. The Game can then be continued 36 and will continue until end is reached 37.

In one embodiment, altering the rule of gameplay may include any rule of gameplay contemplated in the art. Some non-limiting examples include: preventing capture of the game pieces between the first and the second player, preventing enforcement of check rules between the first and the second player, preventing the first player from checkmating the second player and vice versa, any combinations thereof, and/or so forth.

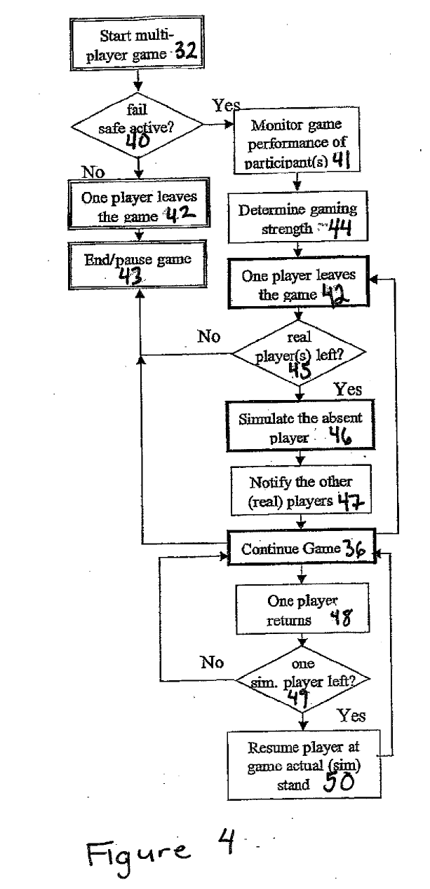

As illustrated in FIG. 4, the method further includes enabling and including a computer player and/or artificial intelligence player. The artificial intelligence player may be any type and/or kind of artificial intelligence player contemplated in the art, or any artificial intelligence player configured to play regular/multiplayer chess taught in U.S. Pat. No. 6,213,873; U.S. Pat. No. 6,120,029; U.S. Patent Publication No. 2006/0148571; U.S. Patent Publication No 2006/0240886; U.S. Patent Publication No 2006/0246972; and U.S. Patent Publication No 2006/0154710; each patent and patent publication are incorporated by reference herein. Indeed, the artificial intelligence player, in one embodiment, may be configured to play chess against multiple players at the same time. Additionally, the artificial intelligence player may be adjusted and/or altered to fit the particular skill level of a player.

Shown in FIG. 4 the method includes: starting a multiplayer game; activating 40 a fail safe; if not activated and one player leaves 42 the game, then the game is paused or terminated 43. If the fail safe is activated then game performance of the participant (s) is monitored 41. Monitoring 41 the game performance of individuals may include determining 44 game strength. If one player leaves 42 the game, then a calculation is made 45, are there any real players left; if no, then the game is paused or terminated. If there are real players remaining 45, then the one more absent players are simulated 46 based on their strengths. Further, the remaining players are notified 47; the game is continued, and so forth as illustrated in FIG. 4. The fail safe activation 40 may include any teachings and/or promotions as taught in U.S. Patent Publication No. 2006/0154710.

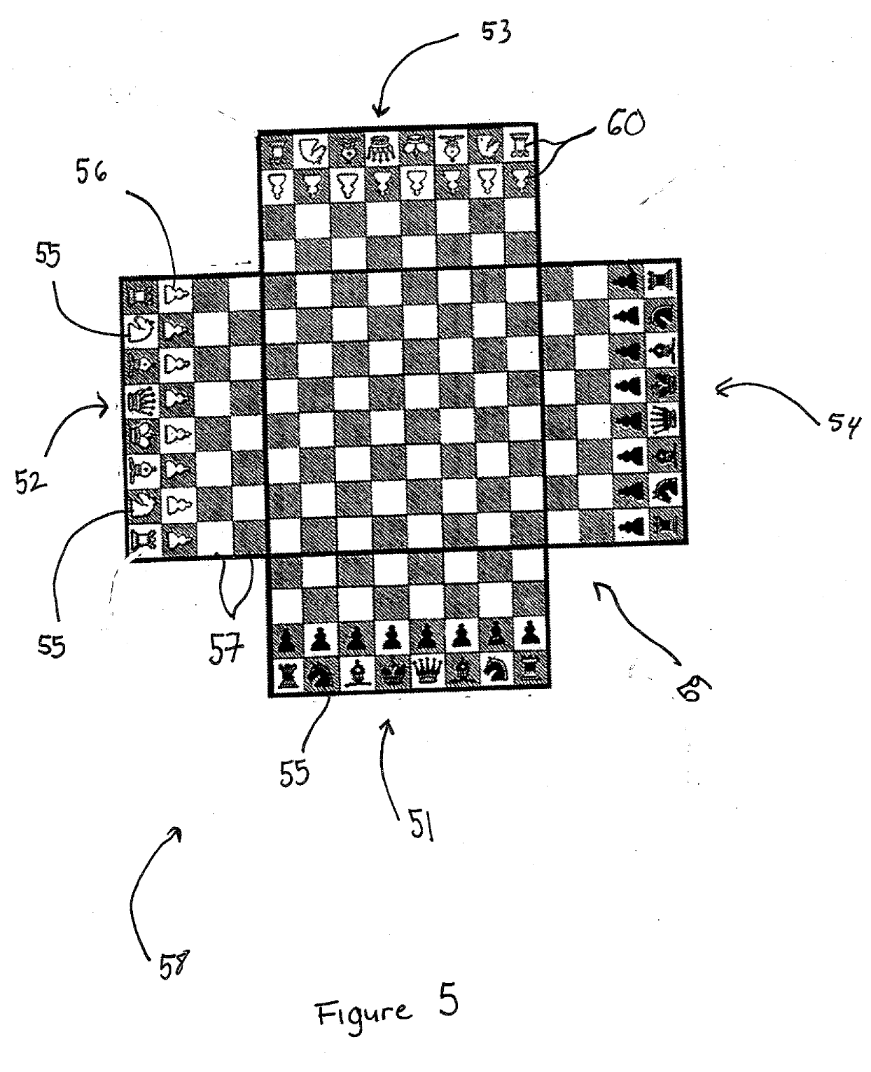

FIG. 5 illustrates a graphical user interface 58 according to one embodiment of the invention. As shown there is a first army 51, a second army 52, a third army 53, and a fourth army 54. The graphical user interface additionally includes a virtual gameboard 59 including a plurality of substantially square-shaped playing spaces 57. In being substantially square shaped the playing spaces need not be square shaped but may be rectangular, may include curvy lines. Further, the playing spaces may be elongated and or distorted square shapes. The virtual gameboard may be any type of game board and/or include any number, configuration, and/or shape of playing spaces contemplated in the art. In a non-limiting example, as shown, the virtual gameboard includes a standard chess board, including 64 playing spaces and one or more game board extensions 100, or wings, which may include a starting point for each army.

As shown in FIG. 5, the graphical user interface includes a three or more armies, each army including a set of game pieces 60 representative of game pieces of a chess game. In a non-limiting example, each game pieces may be governed and/or move during game play according to the standard rules of chess. Alternatively, the knight game piece 55 may move in the direction consisting essentially of: forward three playing spaces and to the side two playing spaces, back three spaces and to the side two spaces, forward two playing spaces and to the side three playing spaces, back two playing spaces and to the side three playing spaces, and any combinations thereof; and the pawn game piece 56 on a first move may move in the direction consisting essentially of: one playing space forward, two playing squares forward, and four playing squares forward. Advantageously, this compensates and allow for easier and more competitive play on the larger virtual game boards.

Additionally, as shown in FIG. 5, the pluralities of armies are each associated with the playing spaces on the virtual game board. In being associated with the playing spaces the armies/game pieces may be displayed on the playing space, adjacent to, and/or so forth. Indeed, once a game piece is captured that game piece may be displayed on the graphical interface in any location and/or manner contemplated in the art, such as but not limited to on a vertical and/or horizontal extreme.

In another embodiment, the system and method for playing chess with three or more armies over a network includes displaying the graphical interface, features, components, and/or functions thereof three-dimensionally. In one non-limiting example, the graphical user interfaces illustrated in Figures be illustrated in 3-D. Displaying the interface in three-dimensions may be accomplished and/or include any graphics and/or illustrations contemplated in the art or as taught in U.S. Pat. No. 7,095,408 issued to Lu et al.; U.S. Pat. No. 6,898,302 issued to Brummer; and U.S. Pat. No. 6,570,575 issued to Wittenbrink; which patents are incorporated by reference herein.

In an additional embodiment, the graphical user interface may include a plurality of animations, graphical and visual arts, images and so forth. Indeed, any animations, graphical and visual arts, images contemplated in the art may be used, such as taught in U.S. Pat. Nos. 7,176,934, 6,388,671, and 5,701,444, which patents are incorporated by reference herein.

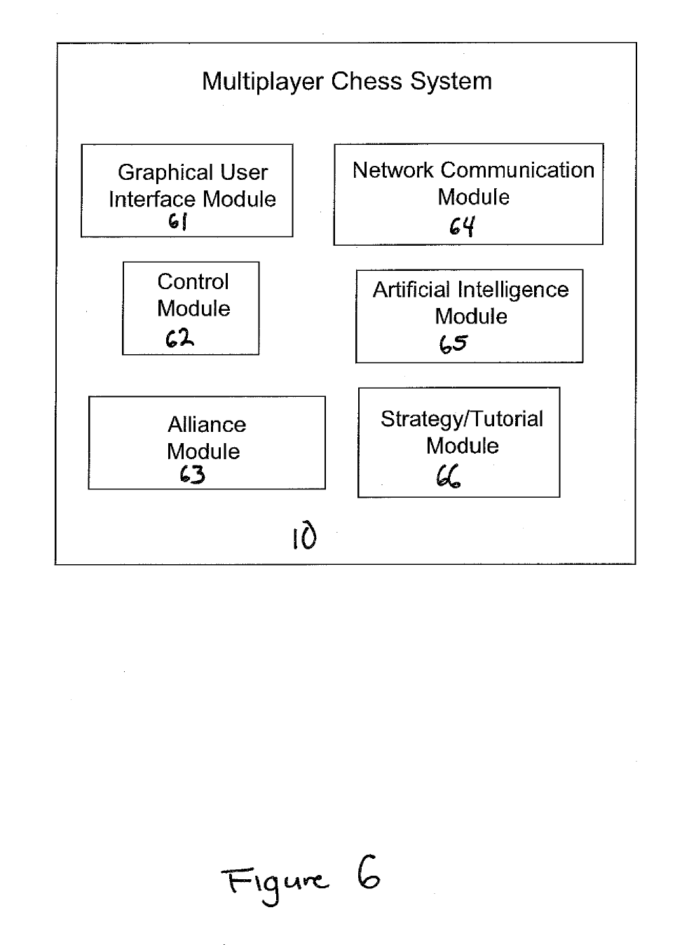

As illustrated in FIG. 6, there is a multiplayer chess system 10, or system for playing chess with three or more armies over a network, each army including a set of game pieces representative of game pieces of a chess game. The system includes: a graphical user interface module (GUI) 61 in communication with the control module, a network communication module 64, a control module 62 in communication with the network communication module, an artificial intelligence module 65, an alliance module 63, and strategy/tutorial module 66. The GUI module comprises instructions for: generating a virtual gameboard, the virtual gameboard including a plurality of substantially square-shaped playing spaces; and displaying a first army, a second army, and a third army, wherein the first army, the second army, and the third army are associated with the plurality of substantially square-shaped playing spaces.

In one embodiment, the GUI module may be configured to generate a graphical user interface including any the features, components, displays as contemplated in the art, or as described herein.

As shown throughout the figures, the system also includes: a first player module in communication with the graphical user interface module and including instructions for controlling the first army; a second player module in communication with the graphical user interface module and including instructions for controlling the second army; a third player module in communication with the graphical user interface module and including instructions for controlling the third army.

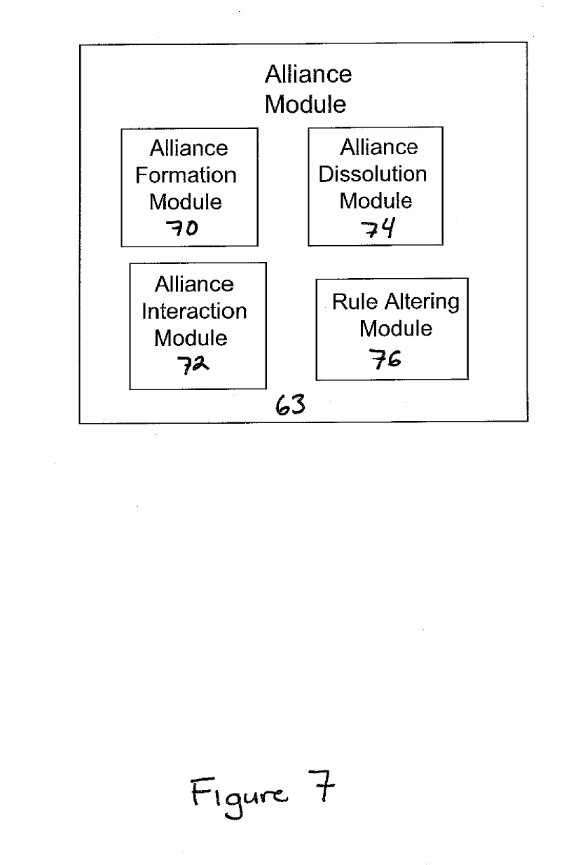

As illustrated in FIGS. 6 and 7, the system includes an alliance module 63 in communication with the control module and/or the GUI module. The alliance module includes: an alliance formation module 70, configured to form one or more alliance among players; an alliance dissolution module 74, configured to dissolve and/or terminate an alliance; an alliance interaction module 72, configured to enable and provide interaction and/or communication between the player modules in an alliance and/or indeed, the game pieces; and finally, a rule altering module 76, configured to alter the rules according to conditions and/or configuration of a formed alliance.

In one embodiment, the alliance formation module and/or dissolution module includes instructions for forming and/or dissolving an alliance among players. The instruction may be selected from the group consisting essentially of: alliance duration, i.e., how long is the alliance (how many turns); how is alliance dissolved/terminated, i.e., automatically, w/ consent of one or both, etc.

Additionally, in one embodiment, there is an alliance interaction module, which includes instructions for governing interaction and/or communication between members of an alliance. The alliance interaction module may include instructions for any type and/or kind of interaction and/or communication as contemplated in the art, or as described herein.

Additionally, in one embodiment there is a rule altering module, which includes instructions for altering the rules of gameplay according to selected conditions. The rule altering module may include instructions for any type and/or kind of rule altering as contemplated in the art, or as described herein.

As illustrated in FIG. 6, the system includes an artificial intelligence module. The artificial intelligence module may be any type and/or kind of artificial intelligence, computer chess player, etc. contemplated in the art or as described herein.

Additionally, as shown in FIG. 6, the system includes a strategy tutorial module. The strategy/tutorial module may be any type and/or kind of strategy tutorial, computer chess player, etc. contemplated in the art or as described herein.

Further, as shown in FIG. 6, the system includes a control module, in communication with the network communication module, the GUI module, and/or the alliance module. The control module may function and/or be configured to manage, administer and control game rules, movement of game pieces, and/or so forth. In a non-limiting example, the control module includes instructions for transferring control of the second army to the first player module upon satisfaction of a condition. The condition may be selected from the group consisting essentially of: checkmate of the first player by the second player, resignation of the first player to the second player, an alliance formation between the first player and the second player, and any combinations thereof. The control module may include any instructions and/or features as contemplated in the art, or as described herein for carry out and/or executing the functions described herein.

In another embodiment, the system and method for playing chess with three or more armies over a network includes displaying the graphical interface, features, components, and/or functions thereof three-dimensionally. In one non-limiting example, the graphical user interfaces illustrated in Figures be illustrated in 3-D. Displaying the interface in three-dimensions may be accomplished and/or include any graphics and/or illustrations contemplated in the art or as taught in U.S. Pat. No. 7,095,408 issued to Lu et al.; U.S. Pat. No. 6,898,302 issued to Brummer; and U.S. Pat. No. 6,570,575 issued to Wittenbrink; which patents are incorporated by reference herein.

In yet another embodiment, the system includes a player ranking module and a player placement module. The player ranking module functions to rank the skill level, handicap, and/or proficiency with the game of quadrachess. The player ranking module may rank player according to a variety of skill levels, speed of play, type of playing strategy, and/or any other type of category contemplated in the art. The ranking may be expressed in any manner or form contemplated in the art, such as but not limited to numerically, symbolically, graphically, textually, and/or so forth. In an additional embodiment, the player ranking module may rank and/or categorize one or more players according to their proficiency with regular chess and quadrachess. This adds the additional benefit of being able to judges a player's proficiency with quadrachess together with his or her ability with regular chess. In a non-limiting example, a person who has skill in regular chess will have a better entering skill level and/or proficiency than a person with no proficiency in either chess or quadrachess.

In still another embodiment, there is a player placement module. The player placement module may function to group a plurality of players according to their levels of proficiency. Further, the player placement module may function to automatically handicap and/or place advantages to a lower skilled player, such as but not limited giving control of more armies and/or game pieces to a player of lower skill.

In another embodiment, the system, apparatus, method and/or program code for three or more army chess includes a setup module and/or setup interface. The setup module and/or setup interface may function to determine and/or enable a user to select skill levels, game type, types of graphical user interface, game duration, alliance rules, and/or so forth. Indeed, the setup module may function to enable a user to setup, select and/or configure any of the functions, features, module, components as described herein.

In yet another embodiment, the system, apparatus, method and/or program code for three or more army chess includes a game recording module, configured to record moves made during the game, game history, points, scores and/or other information associated with the gameplay. Additionally, the game recording module may include instructions for displaying the recorded game data. The game recording module may include any functions, instructions, features, algorithms, etc. contemplated in the art, or as described herein.

### EXAMPLES

The following description illustrates one or more exemplary embodiments of the invention, any features, components; functions, settings, etc. may be incorporated individually and/or together to provide a system and method for playing chess with three or more armies over a network.

The most important differences between chess and QuadraChess are listed below. The section “Strategy Based on Differences between Chess and QuadraChess,” discusses these and other factors as a basis to help you develop strategy tips. Queen Placement: In chess, Queens face each other across the board but in QuadraChess all Queens start on white squares so they face each other on a diagonal.

Multiple Opponents. You need to defeat more armies to win.

Checkmating Multiple Opponents Simultaneously. Yes it is possible to checkmate two or three opponents simultaneously. Let us know if you do!

Multiple Armies. A player inherits the army he defeats and may have multiple armies under his control.

Balance of Skill and Force. QuadraChess offers variations that let weaker players contend against stronger players with extra force balancing what would otherwise be a one-sided game. In one two-player variation one player can control three armies, opposing the other [stronger] player with one army.

More Action between Moves. Three players move before you can respond to a threat. If your King is checkmated, you need to wait your turn to respond˜and the whole situation can change by that time. Checkmate occurs on the turn to move of the player in checkmate, not when checkmate is called by the checkmating player.

Army Capture. a player inherits the remainder of the army he defeats. Thus he tries to checkmate an opponent's King with as little damage to the opponent's army as possible.

Multiple Turns. A player inherits the turn of the army he defeats. Two armies, two turns.

Defending an Opponent. A player may have to defend the army he is attacking to ensure that other players do not destroy his potential forces.

Alliances. Players can ally temporarily to defeat a stronger player, but . . . at the moment of checkmate of the third player, they will probably battle it out between each other for the booty. When the dust settles after the first checkmate, the two remaining opponents often find it advantageous to ally temporarily to defeat the first victor with two armies.

Wild Armies. If a player leaves the game, remaining players can agree to turn the remainder of his army into a “wild army,” i.e., available for the use of any player.

Teams Can Coordinate Attacks. Two partners can coordinate an attack: One can check, the other can checkmate. Or, opponents can team up (ally) temporarily and coordinate attacks to defeat stronger opponents.

### Exemplary Embodiment of Game Rules

The following description illustrates one or more exemplary rule set embodiment (s). Any features, components; functions, settings, rules, modes of play, etc. may be incorporated individually and/or together to provide a system and method for playing chess with three or more armies over a network.

Four players each control one army. Temporary alliances OK. The game is over when a player (the winner) check-mates his one surviving opponent.

To Start Playing

Set up the pieces exactly like chess, all Queens on the center white squares so they face each other diagonally

Lightest color (Yellow) starts first. On Yellow's side of the board, the right˜most square on the first rank should be white.

Just play chess, following chess rules. (Chess rules are given in Appendix I.)

Each color army moves in clockwise rotation order. If a player has an additional army, she moves a piece from that army in its rotation order.

Checkmate: An army is checkmated on its turn to move, not when check-mate is called. See “Game Endings: Checkmate, Stalemate, and Draw,” page 19.

Pawns always move forward relative to their starting position; they may capture (diagonally, as usual) into neighboring wings but then must continue to move forward (relative their starting position).

It's that simple! Advanced play options (such as the extended move for the Pawn or Knight) are suggested in “Optional Guidelines,” on page 22.

General Guidelines

TURN TO MOVE. Each player has one move per turn for each army he controls. Turn to move is always in clockwise sequence, starting with the lightest color.

A condition (e.g., check, checkmate, or stalemate) becomes “real” only on a player's turn to move. Alliance initiates on the turn to move of one of the allies, not when other players are having their turn.

Players may ally only when it is the turn to move of one of the allies and may only dissolve the alliance on the turn of an ally.

MOVING A PIECE IN A CAPTURED ARMY must take place in clockwise turn sequence and not on your other army's turn.

TAKING BACK A MOVE. In serious play, any piece touched must be moved. In casual play, you can take back a move with consent of all other players.

PAWN PROMOTION. Pawns promote when they reach one of the three opposite rows of the board facing them, relative to their starting position.

### Exemplary Embodiment of Alliance, Coalition, and Collaboration

The following description illustrates one or more exemplary alliance formation and/or rule set embodiment (s). Any features, components; functions, settings, rules, modes of play, etc. may be incorporated individually and/or together to provide a system and method for playing chess with three or more armies over a network.

Three kinds of cooperation are possible: Alliance (two partners), Coalition (three partners), Collaboration.

An alliance or a coalition is a formal partnership. A partner's check on a partner's pieces has no force, and' partners cannot make a move that puts the other ally (allies) into danger.

A coalition is three armies joining to defeat one army.

Collaboration is an informal alliance. The offer to cooperate temporarily may be a cunning decoy on the part of one ally to lure the other one into danger. It's a situation pregnant with possibility for participants to turn on each other to gain advantage. In collaboration, one army may attack and capture pieces from the other army. Beware of deception as a tactic in this partnership.

These are our suggested rules for alliances:

Allies must announce their alliance before they can be considered allies

Players may ally only on the turn of one of the allies, not on the turn of the other two players

Allies may negotiate and talk tactics during play.

An ally may not capture their ally's pieces or make a move that exposes their ally to check from an opponent, except to release themselves from check.

An ally's check on an ally has no force.

An ally may not break an alliance when one ally's King is in the line of fire of the other ally's piece.

Both allies must agree to dissolve the alliance before it can be dissolved.

Feel free to make up your own guidelines for alliance or coalition.

QUADRACHESS WINNER. A player wins a Standard QuadraChess game (four opponents) by defeating the last opponent's King. Other variations have their own rules for winning.

CHECK. A player's King is in check when any unallied piece threatens the King. A player whose King is in check must wait until it is his turn to move to get out of check.

KING CAPTURE. In QuadraChess (as in chess) the checkmating piece does not replace the defeated King. A King cannot be captured, only defeated and removed from the board.

EXCEPTION: The only exception in which the capturing piece replaces the King is the following (which describes discovered check): Say Player A moves a piece that opens up Player B's path to directly capture Player C's King. Player C is not in checkmate, but it is now Player B's turn to move. Player 8 may capture Player C's King by replacing the King with her capturing piece. This rare example of King capture and other game-ending examples of checkmates, stalemates, and draws are described in Appendix 4, “Game Endings.”

The piece attacking the King remains on the checkmating square. It does not occupy the square the King was on.

### Exemplary Embodiment of Game Endings

### Checkmate, Stalemate, and Draw

The following description illustrates one or more exemplary rule set embodiment (s). Any features, components; functions, settings, rules, modes of play, etc. may be incorporated individually and/or together to provide a system and method for playing chess with three or more armies over a network.

CHECKMATE: If on his turn the player whose King is under attack cannot remove the threat of check, he is considered checkmated, i.e., defeated by the checkmating player. The checkmating player takes control of the army and turn of the defeated player.

CHECKMATING MOVE. Checkmate or stalemate occurs on the turn of the checkmated or stalemated army, not when the checkmate is issued. The checkmating sequence is described below.

The checkmating piece stays on the square it was on; it does not replace the King. The square the King was on is left empty.

The defeated King is removed from the board.

The checkmating player, who now controls the captured army, moves a piece from the captured army.

CHECKMATING PLAYER: The checkmating player is the first player whose move causes checkmate to be the condition on the turn of the checkmated player. (See Appendix 4, “Game Endings/’)

### Example 1

Player A checks player D. Then Player B checks Player D. Player C moves a piece that opens up a discovered check resulting in checkmate when player D's turn comes. Player C is the checkmating player.

### Example 2

Player A puts Player D in checkmate. Player B also puts player D in checkmate. Player C blocks Player A's checkmate of Player D. Player B is the checkmating player.

STALEMATE: A player is put in stalemate when she is not in check but cannot make a legal move. Stalemate does not manifest until it is the stalemated player's turn to move. Stalemate has different results depending on the number of players on the board and the conditions under which it is made.

STALEMATE BETWEEN TWO PLAYERS A T THE END OF A GAME. Standard chess rules hold for stalemate between two players at the end of a game. Such a game is drawn, and neither player wins.

STALEMATE WITH MORE THAN TWO PLAYERS. There are two kinds of stalemate: forced or self-inflicted.

Forced stalemate—When one player makes a move that puts another player in stalemate and the stalemate is not undone by the stalemated player's move, both the player in stalemate and the forcing player lose.

Self-inflicted stalemate—when a player makes a move that puts himself in stalemate and that stalemate is not undone by his next move, he loses.

In either event, the game can end or continue, depending on the rules agreed to at the start of the game. Other stalemate examples are described in Appendix 4, “Game Endings.”

DRAW: The rules for games ending in a draw in QuadraChess follow the rules for games ending in a draw in regular chess. A game ends in a draw when:
No player has enough pieces left on the board to force checkmate against another (all armies are reduced to only the King).
The same position on the board is repeated three different times (as a result of players moving pieces back and forth perpetually).
Fifty moves are made by each side without a Pawn being moved, a piece being captured, or a King checkmated.
There are only two players left on the board and stalemate occurs.

When one of these four situations occurs, the game ends in a tie among all players remaining on the board (players who had been checkmated prior to the draw are not included; they still lost).

For rating purposes, players who checkmate will be given credit, but they still are not considered winners of the game.

### Additional Exemplary Embodiment(s)

The following description illustrates one or more exemplary rule set embodiment (s). Any features, components; functions, settings, rules, modes of play, etc. may be incorporated individually and/or together to provide a system and method for playing chess with three or more armies over a network.

Options should be announced and agreed to before rather than during play.

EXTENDED MOVES. The Pawn and Knight lose capability on the larger board area, but two options restore value to these pieces: Enhanced Pawn option, Knight's Lance option.

ENHANCED PAWN. On its first move, a Pawn may advance one, two, or four squares. On subsequent moves, it may advance one square.

Standard chess rules hold for en Passant capture of a Pawn making an enhanced pawn move. If a Pawn moves forward one, two, or four squares, en passant capture by the next player in rotational turn would take place by diagonal capture in the same way that the Pawn could be captured in the standard en passant move in chess.

KNIGHT'S LANCE. The standard Knight's move is two spaces up and one over. In the Knight's Lance move, the Knight may move three spaces up, then two over.

The Knight's Lance move effectively doubles the number of squares the Knight can cover (16 squares compared with the standard Knight move covering eight squares), thus making the Knight as deadly as the Bishop. This puts the Knight into better balance with the other royal pieces, and increases its lethal impact (and the game intensity).

In the Knight's Lance move the Knight still lands on an opposite color square so both Knights can still attack pieces on dark and light squares. If the player selects the Knight's Lance option, the player may use either a standard Knight move or the Knight's Lance (i.e., the extended Knight) move.

ABANDONED ARMY. If a player leaves before the game ends and abandons his army, remaining players can select one of two options to continue play:

The abandoned army may become a “wild” army and its pieces moved by all players. Players can move a piece from their own army or the wild army. See “Wild Army,” below.

The abandoned army can just be left on the board with the other players moving around it (and it has no force or impact on the other players). Pieces can be captured; the army can't be.

Players may improvise their own solution by agreement among all remaining players.

WILDARMY. An army may become wild, if, for example, a player abandons the game before it is over. A wild army is like a “soldier of fortune” army who works for anybody, whose pieces can be moved by any player on the board on the player's turn to move. Its pieces can be captured, but it is not possible to defeat and inherit a wild army because the army has no King.

A check or mate inflicted by a wild army is valid and the control of the defeated army goes to the checkmating player [who used the wild army to checkmate].

A wild-army pawn can be promoted if it reaches any of the three back ranks relative to its starting position.

A player may not move the same wildarmy piece moved by an opponent during the preceding turn.

SHORT GAME. The first army to checkmate an opponent wins.

ALLIANCES-OR COLLABORATION. You can make up your own rules for alliances or collaboration. See page 16 for guidelines on alliances and collaboration.

Standard Game Variations for Two, Three, and Four Players

The following description illustrates one or more exemplary rule set embodiment (s). Any features, components; functions, settings, rules, modes of play, etc. may be incorporated individually and/or together to provide a system and method for playing chess with three or more armies over a network.

FOR FOUR OPPONENTS: For fearless players only. Four players each control one army. Alliances OK. The game is over when a player (the winner) checkmates his one surviving opponent. Requires constant vigilance.

TEAM PLAY Four players play as two sets of allies. The team that checkmates both armies of the opposing team wins. Upon checkmate, the King is removed, but all players retain their turn.

THREE-PLAYER One player controls two armies, and two players control one army each. The player who checkmates his one surviving opponent wins. Temporary alliances OK.

TWO-PLAYER Each player controls two armies. The player who checkmates both his opponent's Kings wins. The short version: the player who checkmates one of his opponents' King wins.

Variations for Four Players (Contributed by Others)

COUNTERMEASURES (DACOSTA). Four players each control one army. The first player who checkmates an opponent's King wins. (This is the short version of Standard QuadraChess.)

BLOCKADE. Two allies on opposite sides of the board each control one army. Two other partners on the remaining two opposite sides of the board each control one army. The first team to checkmate an opposing team's King wins. (This is the short version of Standard QuadraChess, Team Play.)

TEAM (LONG). On adjacent sides of the board, a team of allies each controls one army. The team that checkmates both the opposing team's Kings wins.

TEAM (SHORT). On adjacent sides of the board, two players (partners) each control one army, opposing two other partners each controlling one army. The team that checkmates both opposing Kings wins.

FOX AND HOUNDS (WHITTINGTON). One player is the fox, the other two or three players are the hounds. The fox wins if he stays alive for a certain number of moves (agreed on at the start of the game). The hounds can collaborate but are not allied, and only one of them can win. The fox always moves first. The player who checkmates the fox wins.

KINGS REVENGE (DEL VALLE). Four players each control one army. The winner has to defeat three Kings.

Variations for Three Players (Contributed by Others)

WILDMAN (SHORT). Three players each control one army; the fourth army is “wild” (like the joker in a deck of cards). On his turn, a player may move a piece from his own army or from the wild army. The first player to checkmate an opponent's King wins.

WILDMAN (LONG). Three players each control one army; the fourth army is “wild.” On his turn, a player may move a piece from his own army or from the wild army. The player who checkmates his one remaining opponent's King wins.

PILE-UP (SHORT). One player controls two adjacent armies, opposing two other adjacent players who are partners, each controlling one army. The first player who checkmates an opponent's King wins.

PILE-UP (LONG). One player controls two adjacent armies, opposing two partners, each controlling one army. To win, the player with two armies must checkmate both partners' Kings or the partners must annihilate both Kings belonging to the player with two armies.

NEW YORK (SHORT). On opposite sides of the board, two partners each control one army, opposing one player with two armies; the' first player who checkmates an opponent's King wins.

NEW YORK (LONG). On opposite sides of the board, two partners each control one army, opposing one player with two armies. To win, the player with two armies must crush both partners' Kings or the partners must crush both Kings belonging to their opponent.

Variations for Two Players (Contributed by Others)

DOUBLE-ARMY (SHORT). Two players each control two adjacent armies. The first player who checkmates either of his opponent's Kings wins.

DOUBLE-ARMY (LONG). Two players each control two adjacent armies. The first player who checkmates both his opponent's Kings wins.

FREESTYLE (ROSENTHAL). Two players each control two adjacent armies. On his turn (a player moves twice per turn), a player may move a piece from either of his two armies. The first player who checkmates either of his opponent's Kings wins.

FREESTYLE (LONG). Two players each control two adjacent armies. On his turn (a player moves twice per turn), a player may move a piece from either of his two armies. The first player who checkmates both his opponent's Kings wins.

INSANITY I. On adjacent sides of the board, two players each control one army. The remaining two armies are “wild” (like jokers in a deck of cards). On his turn, a player may move a piece from his own army or from the wild army adjacent to him. The first player who checkmates his opponent's King wins.

INSANITY II. On adjacent sides of the board, two players each control one army. The remaining two armies are wild. On her turn, a player may move a piece from her own army or from the wild army opposite her. The first player who checkmates her opponent's King wins.

CROSSFIRE I. On opposite sides of the board, two players each control one army. The remaining two armies are wild. On his turn a player may move a piece from his own army or from either wild army. The first player who checkmates his opponent's King wins.

CROSSFIRE II. On opposite sides of the board, two players each control one army. The remaining two armies are wild. On his turn a player may move a piece from his own army or from the wild army to his left. The first player who checkmates his opponent's King wins.

HANDICAP. One player controls three armies, opposing a stronger player controlling one army. The player with three armies must defeat the player with one army or the player with one army must defeat all three of his opponent's Kings to win.

### Exemplary Embodiments of Strategy Tips and General Play Suggestions

The following description illustrates one or more exemplary strategy and suggestion embodiment (s). Any features, components; functions, settings, rules, modes of play, etc. may be incorporated individually and/or together to provide a system and method for playing chess with three or more armies over a network.

Most of these strategy tips are valuable in both chess and QuadraChess play. Remember, in QuadraChess both adjacent vultures pose immediate threats.

1. Play to control, occupy, and influence the center of your own wing, but be aware that first attacks will probably be coming from your adjacent sides.

2. Develop pieces as soon as possible, it and try not to move any piece more tit than once before having moved others. An exception is the Knight, which takes longer to get into play.

3. Don't overextend yourself; don't move your pieces in an uncoordinated way; attack with several pieces, not just one or two.

4. Make only essential Pawn moves, for they are irreversible; don't advance precipitously.

5. Don't needlessly bring your Queen out early.

6. Castle early to get the King behind a wall of Pawns and to connect the Rooks.

7. Don't waste time; don't prepare to do what you can do at once.

8. Readily exchange Knights for Bishops (Bishops are more valuable in Quadrachess because of their long-range power).

9. Only after it becomes clear where your best chances lie should you launch a full-scale attack: don't attack blindly.

10. Preferably, attack the army in an adjacent wing (easier to get to).

11. If possible, try to develop and threaten at the same time.

12. Keep your plans flexible, modifying them to reflect the current position.

13. Anticipate points of attack in your own position.

14. Don't sacrifice without a concrete and clear reason.

15. Don't exchange a developed piece for an undeveloped one; don't exchange without a good reason; know the exchange value of the pieces.

16. If under attack, exchange pieces; if attacking, avoid exchanges (by exchanges we mean Knight for Knight, Bishop for Bishop, etc.).

17. Be careful when exchanging pieces; the exchange may result in the other two armies being one piece up.

18. Avoid creating squares in your own wing you cannot guard by Pawns.

19. Use the forces of another opponent to aid your own conquests (for, example, when a player is in check, try to checkmate him.)

20. Similarly, when a player is in check, it presents a good opportunity for you to capture one of his pieces without fear of retaliation from him since, on his next move, he must move to release his King from check.

21. In QuadraChess, you can often avoid capture by occupying a square where you can be attacked by two or more opponents.

22. Concentrate on capturing an opponent's army intact rather than trying to capture pieces; you want to inherit as much force and spoils as possible.

23. Questions to ask yourself before moving: Are there any immediate threats against me? If so, how can I best deal with them?

24. Did my previous move threaten anything and, if so, has my opponent responded to the threat?

25. Can I usefully threaten on this move? If not, can I build or improve my position to create attacking possibilities or to discourage attacks against me?

### Exemplary Embodiment(s) of Strategy Based on Differences Between Chess and Ouadrachess

The following description illustrates one or more exemplary strategy and suggestion embodiment (s). Any features, components; functions, settings, rules, modes of play, etc. may be incorporated individually and/or together to provide a system and method for playing chess with three or more armies over a network.

It will benefit you to be aware of the differences between chess and QuadraChess because differences between the two games call for different strategy and tactics in QuadraChess than you might use in chess.

This section analyzes major considerations in developing your QuadraChess strategy. Some of these considerations include:
The larger dimensions and shape of the board—where is the center of power?
Added opponents (and turns to move) will shift the tactical situations between turns; more spontaneous responses
You are surrounded by and must defend your army from the opponents on either side of you (rather than just one opposite you).
You want to defeat armies as intact as possible.
In chess you know who is attacking you; in QuadraChess, it's not always clear who is attacking you.
That you can ally and use teamwork to checkmate the last player on the boar—but remember, only one player gets the checkmated army. When is it best to ally, to shed an alliance?
That you can inherit spoils of war and use these additional armies to plan tactics and checkmate.

These and other factors contribute vastly increased thinking, logical, strategic, tactical, and spontaneous challenges. Knowing these factors can help you form an appropriate strategy for QuadraChess.

Most of the differences between chess and QuadraChess flow from four major innovations, namely,

Board size, area, and shape
Added opponents
Partnership, alliances, team play
Army capture and play with multiple armies
   Board Size, Area, and Shape

The following description illustrates one or more exemplary embodiments of the invention, any features, components; functions, settings, etc. may be incorporated individually and/or together to provide a system and method for playing chess with three or more armies over a network.

The increased number of squares multiplies the power of the pieces and the power of position (occupying a square). Pieces can attack over longer distances and greater range and dominate more squares or threaten more pieces (from most positions).

Because the increased size of the board diminishes the power of the Pawn and the Knight, QuadraChess offers two options to restore their capability: The Pawn and the Knight may each move one additional space. These moves, the Extended Pawn and Knight moves (the “Knight's Lance” move), described in “Optional Guidelines” on page 22, increase the power of these two pieces and compensate for the larger size of the board.

Additionally the board size and shape affect Pawn movement and promotion. If it captures (diagonally) into an opponent's wing and continues its forward journey in the neighbor's wing toward the edge of the file, a Pawn has fewer spaces to pass through to Queen than, if it has to get to the opposite side of the board (see the Pawn promotion illustration on page 16).

The increased size of the file length from 8 to 16 squares per file and the ability for a Pawn to move into a wing by capturing should be taken into account in formulating strategy. The Pawn in a wing has fewer spaces to travel to promote.

Tactics are usually longer-range and more “guerilla-style” in QuadraChess than they are in chess. The move of each player affects the position of every player on the board. As a result of the board shape (four wings), opponents not only face you, they are on your left and right flank: you start out surrounded. The battle theater is more round than oppositional and it is generally more important to protect your flanks than it would be in chess, where attacks are more likely to come from directly in front of you.

Turns are no longer alternating, and threats cannot be countered immediately. Threats against you have time to build. Three moves are made before your next move, and the two additional turns may radically affect your situation. Negotiation and collaboration become useful instruments to counter any increased threats that may arise from the turns of additional players.

The QuadraBoard shape of a standard board with four four-rank wings offers proportionately the same space for four-army playas chess does for two-army play. However, corners, the middle squares, and all other areas of the board do not have the same value and importance they have in chess. (For example, a Bishop in a corner dominates many more squares than it would in chess. The center field holds far more power and danger than in traditional chess.)

It is a principal rule of chess that Queens face each other in the opening setup. To retain the element of Queens facing each other, Queens start out on the white center squares of the first rank so they face each other on a diagonal. Keep an eye on both adjacent neighbors' Bishops, which can easily threaten your Queen—and every other piece in your wing.

Your strategy, especially in the beginning, should be focused on the neighboring vultures, not the opponent on the far side of the board. The opponent opposite you needs to develop pieces much more than your adjacent opponents would have to before attacking you.

Perhaps one of the safest squares to be on is one that is being attacked by two players.

Multiple Opponents

In chess there is no question about who is mounting an attack against you right now; but who is attacking you at any given time is not so easy to figure out in QuadraChess. Attacks are far more secretive and deadly because of the multiple opponents. The focus of attack can shift from one wing to another in the space of just one move.

The greatest thing about having three opponents is the possibility of simultaneously checkmating three opponents. It's the ultimate QuadraChess challenge. Yes, it is possible, and it gives you the ultimate QuadraChess boasting privilege.

Army Capture

In chess the object is to checkmate the King; in QuadraChess you not only can checkmate an opposing player but also acquire the forces, power, position, and turn of the defeated army. Army capture is a powerful weapon in the battle to win a QuadraChess game.

Gaining an army and the turn of that army are among the best strategic weapons at your command. Using the pieces of a second army to dominate territory, fortify defenses, and formulate attacks and checkmating tactics increase your chances of defeating the other two players.

Your strategy for conquering an opponent should be to capture the army as intact as possible so you can inherit as much of the enemy forces as possible. You may even have to defend the army you are attacking to ensure that other players do not destroy your potential forces.

When controlling two armies it is generally better to balance their power rather than keep one army strong at the expense of the other. That way you can get the most out of each army's power.

Defeating and taking control of an additional army may cause the other two players to join forces against you, and this factor should be taken into account in your checkmating strategy.

Collaboration and Alliances

One of the greatest sources of fun and enjoyment of QuadraChess comes from players planning strategy and tactics in combination play. However, the road to checkmate can be bloodthirsty even between those who join forces. Watch out for betrayal in collaboration. A player might be suggesting collaboration as a decoy to lure you to defeat. Many unexpected surprising possibilities can result from cooperative play.

Collaboration and alliance allow a teamwork approach to attacks. Two players can set up a coordinated attack against a stronger player. One player can set up check, the other player can checkmate.

The social interaction of players is the heart and soul of QuadraChess. This aspect not only adds a powerful social dimension to the game but is another powerful tool in your strategic arsenal.

Develop a strategy for alliance: when to enter into alliance, when to leave an alliance, what your objective is, etc. Successful QuadraChess strategy involves swift and deft merging and disengagement as allies. The vultures lurking on all sides will be trying to determine the weakest, most vulnerable player. Yes, it's true: Everybody IS plotting to attack and defeat you and take over your army.

But in QuadraChess, he who negotiates best has a better chance to win. QuadraChess is extreme chess—the ultimate strategy game-one step beyond chess!

You'll need to think harder, deeper, and stealthier than you do in chess. But when you win, you feel as if you've fought a greater battle on the board than you've ever fought before!

### SUMMARY

In summary, when you start thinking about a QuadraChess strategy,

Develop a beginning, middle, and endgame strategy
Develop a pawn-promotion strategy
Develop a checkmate strategy
Develop a double-army attack strategy
Develop an alliance strategy

If the added opponents, larger board size, extra armies, alliances, and other innovations make QuadraChess more dangerous, they also provide many more opportunities for fun and challenge. They allow more ways of playing chess and make chess more enjoyable on more levels for more people (at one time!).

Sun Tzu's Strategy and Tactics for War

Some of the best principles for QuadraChess strategy and tactics come from Sun Tzu's military classic, “The Art of War.” According to Sun Tzu, the best war policies are to:

Attack the enemy's plans
Disrupt his alliances

According to Sun Tzu, strategic and tactical doctrines of war are based on
Deception
Creation of false appearances to mystify and delude the enemy
Indirect approach
Ready adaptability to the enemy's situation
Flexible and coordinated deployment of separate combat elements
Speedy concentration against points of weakness

These strategies require highly mobile troops and readiness to seize opportunity. Together with heightened awareness, they work superbly in QuadraChess.

“To subdue the enemy's army without fighting is the ultimate skill,” said Sun Tzu.

Keeping Track

The following description illustrates one or more exemplary embodiments of the invention, any features, components; functions, settings, etc. may be incorporated individually and/or together to provide a system and method for playing chess with three or more armies over a network.

Scoring System

Six points are awarded to the four players during the game, as follows: A checkmated or stalemated player receives 0 points; each player remaining in the game receives 1 point.

For example:

If a player mates another player, the mating player receives 1 point, the mated player 0 points, and the remaining players 1 point.
If a third player mates the player with two armies, the mated player gets 0 points, the mating player 1 point, and the player remaining in the game gets 1 point.
The player who mates his final adversary gets 1 point; the mated player gets 0 points.
   Notation Guidelines

Notation is a way to write down the moves so you can record them, review games, analyze moves and strategy, and get better at playing QuadraChess. It can also give you the documented edge in boasting and mocking privileges.

All pieces except the Knight are abbreviated by their first letter. The designation for the Knight is N.

Recording Games

Moves are recorded in QuadraChess using a variation of the algebraic notation system used in regular chess. Algebraic notation in chess gives every rowan the 8×8 board a number from 1 to 8 and every file a letter from a to h. Algebraic notation is objective and absolute: there is only one way to describe any square or record any given move on the board regardless of who moves there.

In Quadrachess, to preserve the attributes of algebraic notation, the board is divided into the center field (the regulation chessboard) and four wings. Each player's wing is laid out as ranks a-h, and files 1-4, from the perspective of that player, the central 8×8 field is laid out a-h, 1-8 from the perspective of the first player to move (Yellow), as in chess.

Every wing square denotes the color of its wing with the first letter of that color in uppercase. The square that the Yellow King starts on is “Yel.” Y for Yellow, e for the e-file, and 1 for the first rank. Squares in the central field do not have an extra letter but are simply “e1, c5,” etc.

When writing down moves, you write the letter of the piece that moved, followed by the square that the piece moved to. So if a player moves a Knight to the e4 square of Orange's field, the move is written, “NOe4.” If more than one Knight from the same army could have moved to that space, put the square of origin in parentheses between the piece name and the destination square: “N(0d2)Oe4.”

Check and checkmate are denoted with the same symbols as in regular chess (shown in the preceding table).

The checkmating move, in which the checkmating player removes the checkmated King and moves a piece from the newly acquired army, is written by putting the checkmating player's color in parentheses before the move that player makes. Example: on Teal's turn, (0#) Qe2 means that Orange makes a checkmating move and now controls Teal's pieces, starting with the move Qe2.

On the next page is a recorded game using this notation system (Appendix 5 has an analysis of this game).

Appendix 6 offers an alternate QuadraChess recording system and an example of that system of recording games as well.

This QuadraChess game was played under standard rules (not extended-move rules), except that in this particular game the starting player, Yellow, played with a black square on the right corner. That means that the Yellow and Orange Kings started on their respective d-files while the Teal and Violet Kings were on their respective e-files. Your QuadraChess games should always be played with a white square in the right corner of the player to move first (Yellow or the lightest color), consistent with chess rules.

QuadraChess (Standard). Chess-played by four opponents on a QuadraBoard. Four regulation chess sets, called QuadraSets, are used. QuadraChess is played exactly like chess, except that the checkmating player inherits the army and the turn of the defeated army (minus the king), and players allowed to partner up.

QuadraBoard. A standard chessboard (of 64 alternating dark and light squares, with 8 squares on each side) and a wing of four rows added to each side of the board.
Field the 64-square area that forms the center of the QuadraBoard
Wing the 8-square, four-rank extension added to each side of the chessboard field
Board shape=a cross
Area=three standard chessboards
No. of squares in a QuadraBoard=192
Ranks (rows)=8 squares across
Files=16 squares up and down
   QuadraSet. A regulation, 16-piece chess set used to play QuadraChess.
   QuadrAlliance. Temporary alliance between two or three opponents.
   QuadraMania! The fear a player feels when he sees three players attacking him. Could also be the rush of just playing the game.

QuadraParty or QuadraSocial. A QuadraChess demonstration marked by its being a media event, or a fun, social event, a personality event, a community event . . . a unique, highly entertaining way for men and women . . . to meet and demonstrate personal, character, and intellectual qualities.

IQ Society. International QuadraChess Society, the social club for QuadraChess players. Holds tournaments and exhibitions. Rates players. Arbitrates disputes, issues news, and keeps players connected.

The United States QuadraChess Federation (USQF). A parallel to the USCF, the United States Chess Federation, to be formed. Watch for an announcement on QuadraChess.com.

Appendix 1˜Chess Rules and Moves of Play

The following description illustrates one or more exemplary embodiments of the invention, any features, components; functions, settings, etc. may be incorporated individually and/or together to provide a system and method for playing chess with three or more armies over a network.

The Idea of Chess

QuadraChess rules are based on chess rules. This section is for those who want to learn or review the rules of chess. After reviewing the moves and rules for chess, a player will have the basic foundation to play QuadraChess. We suggest playing several games of chess before playing QuadraChess.

Chess is a mental martial art, a struggle for survival played on a board under agreed-upon rules by two participants in direct opposition to each other. The object is not to acquire more than the other opponent, but rather to wage a strategic and tactical simulated battle to the death in which players try to defeat, or “checkmate, n their opponent. It is played by accepted rules for combat both players follow to defeat their opponent.

Moving alternately, players advance into each other's camp, and attempt to capture one another until one player is either checkmated, resigns, or there is a draw.

Chess is the only martial art that can be played and Won purely in the mind by players. Board and pieces are not essential to the game. Much like any other martial art, it is a sport of mental dominance and will, requiring great mental intensity and concentration.

Chess Equipment

Chess Board. The battlefield where the game of chess unfolds, where two minds make visible their struggle for mastery of time, space, and movement of material to defeat their opponent.

Chess is played on an 8-rank/8-file board of 64 alternating light and dark squares. Ranks are the horizontal rows, files the vertical lines of squares from your side to the other player's side of the board. Pieces should be set up such that each player has a light corner on the right side of the first row of the chessboard.

Chess Pieces. The playing pieces are comprised of two 16-piece chess sets, light and dark, one set per player. Each player's set is divided as eight “Royalty” pieces, set up on the first row, and eight Pawns, on the second row (each Pawn sits in front of a royalty piece). The 16 piece set for each player consists of: 8 Pawns, 2 Rooks, 2 Knights, 2 Bishops, 1 Queen, 1 King

The pieces have different ranks, values, and abilities (potential for damage to the enemy), and different ways of moving, as described on the next page.

Piece Moves

Each chess piece has its own way of traveling from one square to another. The pieces, their symbols, and the moves they can make are described on the following pages.

Pawn. Pawns are the foot soldiers of chess. They form a protective barrier for the pieces behind them. They serve both as shields and as expendable pieces to harass and threaten opposing pieces.

The Pawn moves in a forward direction only. From its starting position, the Pawn may move one or two squares. However, after its first move, it may only move one square at a time. Since the Pawn cannot “jump over” any piece, any piece in its path blocks its further advance.

Pawn Capture. A Pawn may only capture by replacing an enemy piece that occupies the left or right square diagonally forward (in other words, it captures on the same color square it moves from).

Pawn Promotion. If a Pawn reaches the opposite side of the board (the eighth rank, relative to the starting position of the Pawn), where it can move no further, it can be traded for any other piece in the set except the King (and may even be traded for a second Queen). The trade (promotion) must take place immediately when the Pawn reaches the opposite side of the board.

Rook. The Rook moves along the ranks and files (forward or backward or side to side) in any direction. It cannot move diagonally or in two directions on the same move. To capture, it takes the place of the piece on its landing square.

Knight. The Knight moves in an “L” shape, two squares up and one at a right angle (actually, the Knight moves directly through the centers of the squares from point to point in a straight line). It always lands on the opposite color from which it started. It can only capture a piece on the square it reaches on the completion of its move. It is the only chess piece that can “jump over” its own or its opponent's pieces. Its attack cannot be blocked. It must be captured to eliminate its threat.

Bishop. Each player has two bishops, one on alight square, and one on a dark square and commands that color only. Bishops move diagonally, from corner to corner on the squares. Each bishop may move only on the color it starts on and in only one direction per turn. To capture, the Bishop replaces the piece on its landing square.

Queen. The Queen is the most powerful piece on the board. She can move like the Rook or the Bishop. She may move as many squares as she wishes in any direction (but only in one direction per turn) so long as no other chess piece blocks her path. To capture, she replaces the piece she captures on her landing square.

King. The King may move one square at a time into any adjacent square. He may not move to a square where he would be liable to attack by an opposing piece or in check by an enemy King. Further, in castling, the King may not move across any square under attack. (see “Castling,” next page).

Movement and Capturing

Movement

Lightest color (Yellow) moves first.
All pieces except the Pawn may move forward or backward.
No one may touch their own pieces out of turn or their opponent's pieces without saying “I adjust.”
If a player touches a piece, he has to move it.
Players may not take back a move (unless by consent in casual games).

ILLEGAL POSITION. If a player discovers an illegal position, the pieces on the board must be reinstated to what they were before the illegal move was (moves were) made.

EN PASSANT (“[CAPTURE] IN PASSING”). If on the first move of a Pawn a player opts to move the Pawn two squares forward and passes an opponent's Pawn, the opponent, on his next move, may capture the player's Pawn by moving his Pawn diagonally as if the Pawn first moved had gone forward one square only.

CASTLING. The only play in which two pieces may be moved simultaneously is called “castling.” Only the King and a Rook participate in this move. To castle, the King moves two spaces in either direction on rank 1, and the Rook nearest the new location of the King is then (or simultaneously) placed on the opposite side of the King (on rank 1). The two moves are considered as one move.

Castling is permitted only if the following conditions apply:

All the squares between the King and Rook are unoccupied.
It must be the first move for both the King and the Rook.
The King is not in check.
No opponents' pieces commands squares between King and Rook.
   Game Endings: Check, Checkmate, Stalemate, and Draw

THE WINNING PLAYER. To win in chess, a player must defeat an opponent's King (this is known as checkmating the King). A King cannot be captured)(The game is over when it is the turn to move of the player in check and the player in check cannot get out of check.

A player can also win if his opponent gives up.

CHECK. The King is in check when it occupies a square that is under direct attack by the opposing army.
A King may not check another King. ‘i’ The player in check must respond to the check on the next move.
The player in check may intercept the check by putting his opponent in check, thereby forcing the opponent to move out of check himself.
It is courteous, but not obligatory, to announce check.
The checked player can get out of check by
Capturing the attacking piece.
Moving the King to a square where it is not under attack.
Interposing a piece between the opponent's attacking chess piece and his own checked King.

CHECKMATE. If the player whose King is under attack cannot remove the threat of check on his next turn, he must accept his defeat by the checkmating player, and the game is over.

STALEMATE. If a player's King is not in check and on its next move can only move into check, it is stalemated, and the game ends in a draw.

DRAW. A game can be a draw if
Two players agree.
Upon demand by one of the players if the same position is played three consecutive times.
If a player does not have enough pieces to mate.
   If 50 moves are made without a capture or a Pawn move.

### Exemplary Embodiments of Game Endings

### Example 1

### Capturing an Ally's Pieces to Prevent Checkmate

Q: Yellow and Teal are allies. Violet has issued checkmate on Teal. It's Yellow's turn. Yellow could save Teal from checkmate but only by taking one of Teal's pieces. Teal would certainly agree to letting Yellow take his piece because otherwise the game is over for him. May Yellow take his ally's piece to save him from mate?

A: The chess rule here is that you cannot take your own pieces to save yourself from checkmate; therefore, allies cannot take allies' pieces either. Players can agree to make this exception to allow an ally to capture one of their pieces if they choose, but we recommend not doing so because it contradicts chess rules.

### Example 2

### Alliance to Prevent Checkmate

Q: Teal has issued checkmate on Yellow, with Violet's pieces helping to cut off Yellow's escape routes. It's Yellow's turn. Violet does not want Teal to get Yellow's army, which is what will happen if Yellow cannot escape checkmate. Can Violet ally with Yellow, letting Yellow's King escape to a square covered by one of Violet's pieces?

A: This sudden alliance under duress of checkmate is a great idea! Since it is Yellow's turn to move, he can suggest partnership with Violet.

In online play alliances can only be established at the beginning of the game.

### Example 3

### King Capture/Discovered Check

Q: Teal and Violet are allies. Violet has moved his King onto a square that one of Teal's pieces controls (but the check is null because they are allies). It is Yellow's move. Yellow checkmates Teal, and Teal's army and turn go to Yellow. Yellow must now move a piece from the Teal army. The piece from the Teal army Yellow chooses to move is the piece that controls the square the Violet King is on. Can Yellow use the Teal piece to take the Violet King?

A: Yes. This move demonstrates how QuadraChess takes the rules of chess (King defeat) one step beyond the borders of chess (King's army capture). Even though it's not checkmate, this is a situation where a King can actually be captured like any other piece. If you checkmate Teal and then on Teal's turn capture Violet, congratulations on a great combo army capture. The Violet army now belongs to you; you are the capturing player of Violet's army, just as if its King were checkmated. Kudos on the double army capture!

### Checkmate Example 1

Q: Yellow puts Orange in check. Teal puts Orange in check, which, because of Yellow's position, is effectively checkmated. Violet takes an Orange piece and in doing so changes Yellow's check into a checkmate. It is Orange's turn, and he cannot escape either checkmate. Who gets the Orange army?

A: Teal. He checkmated the Orange King first. Yellow's checkmate of Orange occurred on Violet's move-after Teal's move. Thus, Teal was the first to checkmate. Teal inherits the Orange army.

### Checkmate Example 2

Q: Yellow puts Orange in check. Teal puts Orange in check. Violet takes an Orange piece that turns both Yellow's and Teal's checks into checkmate. Who gets the Orange army?

A: Yellow, because he was the first to make the check that became checkmate. Violet cannot claim the checkmate because none of his pieces put Orange in check.

### Checkmate Example 3

Q: Yellow puts Orange in checkmate. Teal puts Orange in checkmate. Violet blocks the checkmate from Yellow. Who gets Orange's army?

A: Teal. He had Orange in checkmate before and after Violet moved.

### Stalemate Example 1

Q: Yellow moves into a stalemate position. The other players all move, and when his turn comes back around, he is still in stalemate. What happens?

A: Yellow loses for putting himself in stalemate. Depending on the game options (agreed upon by the players at game start), one of these events will happen:

1. Yellow's King is removed from the board and his army remains “dead” in place as the other players move around it to finish the game.
2. Yellow's King is removed and his army becomes “wild” and usable by any other player.
3. The game ends and all the other players win.

### Stalemate Example 2

Q: Teal takes a move that puts Yellow in a stalemate position (Yellow cannot move any of his pieces, for example). Violet and Orange both move, and on Yellow's turn he is still in stalemate. What happens?

A: Yellow loses as a result of being put in stalemate, and Teal loses for forcing it. Depending on game settings:

1. Yellow and Teal's Kings are removed and their armies are dead, and the other two players play the remainder of the game against each other.
2. Yellow's King is removed and his army becomes “wild” and usable by any other player.
3. The game ends with the players not involved in the stalemate sharing the victory.
   1. PYd4

This classic opening move is instantly recognizable by chess players as it advances a Pawn into the center of the board and opens up diagonals for the Queen and King-Bishop. It remains as strong in QC as now those pieces are already looking down into opposing wings. There is a danger with this, though: if the enemy on either side moves his own King Pawn, the diagonal will be open for an exchange of Queens or Bishops. Such an exchange would be a mistake this early in the game because the exchanging sides lose material while the other two armies do not. While you may know better than to make such early exchanges, you cannot assume that your opponents will, too, and you should play to avoid situations on the board where they can exchange with you.

V1: PVg2

Only in recent years did opening with a Knight-Pawn move become popular in regular chess. In QuadraChess it is particularly strong because it lets you put your Bishop on an even longer diagonal than the one it starts out on (this maneuver is known as a fianchetto). Because the center of the board is so much farther away from the starting positions in QuadraChess, there is less pressure to take control of it and more time to fortify your own wing. You should be careful opening with a fianchetto if your opponent is doing the same along the same diagonal; the one who gets his Bishop there first will have more pressure on the other's wing.

T1:PTb4

Advancing the Pawn two squares instead of one is a poor choice here because it cannot be protected without moving another Pawn, and it also cuts off the Ta3-0h3 diagonal to the Teal Bishop. Some people advance the Queen-Knight Pawn twice to open in regular chess, and the position is playable but not very strong.

Y2: BYf4

Strong in regular chess and QuadraChess•because it gets the Bishop out where it can quickly get to any other place on the board and does not obstruct the development of the other pieces.

V2: PVf4

It can be dangerous to advance the Pawns near your King this early in the game, plus the Pawn now obstructs the Queen-Bishop's starting diagonal. That's not a bad thing, but it does limit Violet's development options. On the plus side, Violet can now move his King-Knight without obstructing this Pawn. Staunton was a big fan of this move.

03: NOf3

This move wouldn't be necessary to defend the d-Pawn if this game were being played with Knight's Lance rules, but even then this is still a good developing move.

T3: RTb1

Teal intends to bring her Rook out by RTb1-Tb3-Ta3. Getting the Rook out this early in chess is poor strategy, and in QC it's not much better, for the same reason: doing so wastes moves that would have been better spent developing other pieces toward the center of the board. Plus, it's easy for enemy pieces to chase the Rook around once it's out.

V4:PVb3

Logical, since the other diagonal was blocked, but there is an issue: if Violet intends to castle King-side, he must defend the Vg1-0b1 diagonal for his King's safety's sake. For this reason, it would make more sense to place his Queen-Bishop on this diagonal rather than fianchetto it. This is still playable, though.

T4:NTh3

In chess, developing the Knight to the side like this is generally frowned upon; Knights more than any other piece must be in the center of the board to fully exert their power. Developing it to the side here gives it an inroad to Orange's wing, but not one that much can be made of without support from other pieces.

05: BOd3

Orange's balanced development puts him in a solid position to advance into the center with Pawn moves, foray into either adjacent wing with minor pieces and castle on either side. Ditto for Yellow, though Yellow's position is a bit less dynamic at this point.

V6: BVb2

This threatens to take Yellow's g-Pawn. Right now this Bishop is the only piece pointed at Yellow and can easily be blocked by expanding Yellow's Pawn frontier.

06: POc4

Orange seeks to forestall possible exchange of Queen-Bishops with Teal. When possible, advancing your Pawns is one of the best ways to protect your pieces and expand your zone of control. At this early point in the game, the trick is to do this while keeping enemy Bishops' diagonals closed so they can't snipe you from their wings. Once your pawns are farther out and your pieces have more room to maneuver, enemy Bishops don't constrict your mobility as badly as they do initially.

Y7: NYf3

While this is the natural development move of the Knight, PYf3 would have been slightly better. Violet won't want to exchange his Bishop for this Knight, but the Knight is now pinned because if it moves again, the Bishop can take the g-Pawn. PYf3 would support an e-Pawn advance and thereby eliminate Violet's Bishop's attacking chances along that diagonal. Yellow will still need to advance his e-Pawn before he moves either that Knight or the g-Pawn.

Y8: Be1

Nice because it gets off the diagonal with Teal's white-square Bishop and simultaneously threatens Teal's Knight.

V8: 0-0

Dangerous, because Orange's Queen and Bishops are staring right at his King along those diagonals.

08:0-0-0

He could give discovered check to Violet with PdB, but to no real end other than advancing his Pawn.

T8: BTb2

Big mistake because it hangs the Knight at h4.

V10: NYh4

Another way to move the Knight without losing the g-Pawn. He should follow up with PYt3 or PYe4.

V10: PVd3

Hangs the Ve3 Pawn for no good reason.

010: NOc3

Orange is playing very cautiously and doesn't want to take the loose Pawn just yet, even though he could. Having a solid position is more important than taking one extra Pawn.

Y11: NYa4

Big mistake because it hangs the b1 Bishop.

V11:PVc4

He had a chance to defend the e-Pawn but blew it. Otherwise, this would have been a good move.

012: BOd3

If he leaves the Bishop in Violet's wing, he could lose a piece if Violet attacks it and Teal's Bishop takes his Knight in the next turn.

Y13: NVg4

Leaves the g-pawn unprotected, but doesn't hang the Tb4 Knight since Teal should save her Rook instead.

V13: QVc1

Violet had nothing to fear from the Vg4 Knight; he could have taken the g2-Pawn straight away.

T13: QxTb4

Saving her Rook was more important than taking Yellow's Knight. Plus, now her King is vulnerable to Orange's Queen!

014: Ng8

Orange could take the Teal c-Pawn now, but doesn't want to send in the Queen without more backup. He's giving Teal a chance to defend her vulnerable spot, but if he can bring enough force to bear on her already weakened position, he can force his way in without having to rely on her making mistakes.

T14: Qg4

Failing to protect her c-Pawn. Now her•King is in dire peril.

V15: Bb3

Normally, it's no skin off Violet's nose what happens to his opponents, but when there is a threat of checkmate to an enemy, Violet should be playing to help ensure that nobody winds up with an extra army so soon in the game. Bd1 might have helped Teal escape checkmate. He should have at least pointed the threat out to her verbally.

015: QxTc2

Threatens checkmate on Teal with a subsequent QTc1. Now, any move by Teal except PTf3 will result in quick death for her King.

T15: Qxh4

And so she spells her own fate.

Y16: NVg4

There's nothing Yellow or Violet can do to stop Teal's death now, but since they're now going to have to deal with two armies under the Orange player's control, they should be teaming up against him rather than threatening each other as with this move.

T16: (0#)PTe4

Now that Teal has been checkmated, the Teal King is removed from the board and the Orange player controls the Teal pieces, starting with this move.

Y20: RYh1

Needlessly hangs the Rook. Much better would have been Rg5, threatening the Orange Bishop and lining up for a Rook doubling on the g-file.

020: QxYf2

Orange could gladly exchange his Bishop for Yellow's Rook, but at this point he likes the Bishop where it is and is content with increasing the pressure on both enemy positions, angling for checkmate if possible.

Y22: NxVd3

Yellow could not recapture on Yh1 because then 022: QxYc2+ and T22: Rxa2 would be mate. Still, though, he insists on weakening his only chance of surviving: the Violet army.

022: BxVc3

Orange judges that after V23: QOd3+, 023: ROe2, he'd be safe from further enemy attacks on his King. He must not overlook the Og2 square, though.

V23: QOc2

Looks dangerous, but the shark has no teeth. Violet should be helping Yellow defend against the enemy Queens and Bishop. QxTd4 is tempting, but loses the Queen after 023: BYe4 and T23: Rxa2+.

Y24: RxYc2

Leads to checkmate as the following sequence shows, though taking with the Queen would have lost almost as quickly after 024: BYe4 and T24: QxYc2+.

V24: Rb4

The first move made after Yellow and Violet finally declare their alliance, which forbids them from taking each other's pieces or Kings. There's now a credible threat against Orange's King, but it's too late for them to act on as Orange strikes decisively in his next moves.

V26: KVf2

Even though he could legally move here since he was allied with Yellow, he would have postponed the end by moving somewhere not in that Knight's control.

Y27: O#NxVf2#

When Yellow was checkmated, the Orange player gained control over the Yellow pieces; because Violet's King was already in a square where the Yellow Knight could move, it was actually possible to capture the Violet King with this move.

Appendix 3—Force and Power in Chess and Ouadrachess

Why is Chess a Powerful Game?

Chess is an epic battle of domination, a battle to the death between two armies, but where does chess derive its power?

The game itself has lasted so long in its current form because of its exquisite balance of Power Density, the combination of variables that define the interactions of power between the pieces and the board.

Another way to say Power Density is the tension created by the tactical maneuvering of the pieces on the board. Power Density is a number that can be calculated mathematically, but the number itself means little; what is important in chess is that the power relationships between players, pieces, and the board combine to form the perfect strategy game.

Why do we care about this? Because any variation of chess that aspires to be as involving and exciting as the original should have a power density as close to that of regular chess as possible, and QuadraChess is no exception.

In playing the game, a player's power is the use and threat of force in combination with dominance over territory that limits an opponent's ability to move and retaliate. The fewer the options for the opponent, the greater the power of the player.

A piece gains power from

The range and flexibility of how it moves and attacks and
The range of its attack, the latter factor being relative to the size, area, and shape of the board
   So, we may say that chess (and QuadraChess) derives its Power Density from:
The unique object of the game: nothing less than total annihilation of the opposing force (in QuadraChess, opposing forces)-a zero-sum game.
Moving by turns in chess, or in QuadraChess, alternating moves of four opponents juggles power (for example, in QuadraChess, two other players move before a player can retaliate to a threat, which mat affect the threat). A player has more power than her opponents(s) when it is her turn to move; the more turns, the greater the power of the player.
Size, shape, and area of the board.
Number and type of pieces relative to the board, particularly the powers of the pieces, i.e., the individual potential capabilities of the pieces to move and operate on the board and reach positions from which they can dominate, threaten, block, or capture pieces.

In general, royalty pieces are more powerful in QuadraChess than chess because they can control or move to a greater number of spaces than royalty pieces in chess. Relative to chess, the power of Pawns and Knights is diminished in QuadraChess.

The Extended Pawn option puts the Pawn into better balance with the larger span of the board. The Knight's Lance option, extending the reach of the Knight (three spaces up and two at a right angle), puts the Knight into better balance with the larger span of the board and increases the Power Density slightly.

Power Density Factors

1. Mobility of a piece, determined by the maximum number of squares a piece can reach.
2. Collective Mobility; represented by the maximum number of squares reachable by all the pieces in all the sets taken together.
3. Power Density, which equals the collective mobility in relation to the size of the QuadraBoard (the number of squares) compared with a chessboard.
   Measuring Power Density of Quadrachess Compared with Chess

Power Density is a direct measure of the Tactical Intensity of a chess design and measures the power of the pieces to operate on the board, given the size and area of the board and the access of the pieces to squares from different positions on the board. In chessboard design the ideal is to keep the Power Density as close to that of chess as possible. Power Density of chess and QuadraChess are nearly equal in value. Power Density in chess is calculated by the five steps on the next page.

Shape of the Playing Board. The first element to consider in determining the Power Density of QuadraChess related to chess is the shape of the playing board. The QuadraBoard is a special chessboard design in which a wing of four rows is added to each side of a regulation chessboard. The resulting shape is not a square, but a cross (X or +).

Area. For considerations of preserving traditional Tactical Density on the board, area is the dominant factor. Obviously too much room will thin out and dilute playing tactics, while too little will crowd and cramp them. With four ranks added to each side of a standard board, file length is doubled to 16 squares, while rank length remains the same, 8 squares. Files are now doubled, and area is tripled. Spatially the play area now equals that of three standard chessboards (192/64).

Collective Mobility. Area is not the only important factor in calculating Tactical Density. Collective Mobility is another important factor. Collective Mobility is calculated in the following five steps:

Step 1: Count the number of spaces that each fighting piece commands from a center square, a side square, and a corner square.

Step 2: Multiply the number obtained in Step 1 times the number of pieces of that unit in all sets on the board.

Step 3. Multiply the product of Step 3 times the number of sets on the board (4). This resulting number is the collective mobility.

Step 4: Divide the number obtained in Step 3 by the number of board spaces.

Step 5: Divide the number obtained in Step 4 for QuadraChess by 64 (the total spaces in standard chess).

QuadraChess Power Density

If we do these steps for both chess and QuadraChess and see how they compare, the QuadraChess calculation assumes the closest Power Density to chess with the extended Knight and Pawn moves.

With four players and extended moves, the Power Density ratio of QuadraChess to chess is 1.090:1.000, slightly greater than chess. Without the extended Knight and Pawn moves, the ratio is 0.924:1.000, slightly less than chess.

With three players and no reduction in playing area, Power Density drops to exactly one-half its four-player density, 0.545, or 54.5% of the Power Density of chess. Versions with three added ranks have a Power Density rating of 1.320.

As long as there are four armies on the board, Power Density of QuadraChess will always be within 10% that of chess. There are ways to fine-tune the Power Density calculation process, but we think this analysis goes far enough to demonstrate how closely Quadrachess recreates the tension of chess gameplay.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A method for playing chess with three or more armies over a network, each army including a set of game pieces representative of game pieces of a chess game, the method comprising the steps of:
generating a graphical user interface, according to a first mode, including:
a virtual gameboard including a plurality of substantially square-shaped playing spaces;
a first army;
a second army; and
a third army;
wherein the first army, the second army, and the third army are associated with the plurality of substantially square-shaped playing spaces;
providing control of the first army to a first player over a network;
providing control of the second army to a second player over a network;
providing control of the third army to a third player over a network; and
forming an alliance according to a second mode, between the first player and the second player.

2. The method of claim 1, wherein the third player comprises artificial intelligence designed to simultaneously compete against the first player and the second player.

3. The method of claim 2, further comprising altering the skill level of the artificial intelligence.

4. The method of claim 1, further comprising a fourth army associated with the plurality of substantially squared-shaped playing spaces.

5. The method of claim 4, further comprising providing control of the fourth army to one of the players selected from the group consisting of: the first player, the second player, the third player, a fourth player, and any combinations thereof.

6. The method of claim 1, further comprising transferring control of the first army to the second player upon satisfaction of a condition.

7. The method of claim 6, wherein the condition is selected from the group consisting essentially of: checkmate of the first player by the second player, resignation of the first player to the second player, an alliance formation between the first player and the second player, and any combinations thereof.

8. The method of claim 1, further comprising communicating data in a second mode between the first player and the second player through a closed channel to the exclusion of the third player.

9. The method of claim 1, further comprising altering the rule of game play upon the formation of an alliance between the first player and the second player.

10. The method of claim 9, wherein altering the rule of game play is selected from the group consisting essentially of: preventing capture of the game pieces between the first and the second player, preventing enforcement of check rules between the first and the second player, preventing the first player from checkmating the second player and vice versa, and any combinations thereof.

11. The method of claim 1, further comprising:
moving a knight game piece in the direction consisting essentially of: forward three playing spaces and to the side two playing spaces, back three spaces and to the side two spaces, forward two playing spaces and to the side three playing spaces, back two playing spaces and to the side three playing spaces, and any combinations thereof; and
moving a pawn on a first move of the pawn, in the direction consisting essentially of: one playing space forward, two playing squares forward, and four playing squares forward.

12. A system for playing chess with three or more armies over a network, each army including a set of game pieces representative of game pieces of a chess game, the system comprising:
a network module configured to communicate data over a network;
a control module in communication with the network module;
a graphical user interface module in communication with the control module, and configured to interface with a user, the graphical user interface module comprising instructions for:
generating a virtual gameboard, the virtual gameboard including a plurality of substantially square-shaped playing spaces;
displaying a first army, a second army, and a third army, wherein the first army, the second army, and the third army are associated with the plurality of substantially square-shaped playing spaces;
a first player module in communication with the graphical user interface module and including instructions for controlling the first army;
a second player module in communication with the graphical user interface module and including instructions for controlling the second army;
a third player module in communication with the graphical user interface module and including instructions for controlling the third army; and
an alliance formation module in communication with the graphical user interface module, and configured to enable alliance formation between the first player module and the second player module.

13. The system of claim 12, wherein the third player module comprises artificial intelligence, the artificial intelligence comprising instructions for simultaneously competing against the first player module and the second player module.

14. The system of claim 12, wherein the control module includes instructions for transferring control of the second army to the first player module upon satisfaction of a condition.

15. The system of claim 14, wherein the condition is selected from the group consisting essentially of: checkmate of the first player by the second player, resignation of the first player to the second player, an alliance formation between the first player and the second player, and any combinations thereof.

16. The system of claim 12, wherein the alliance formation module includes instruction for altering a rule of game play upon formation of an alliance between the first player module and the second player module.

17. The system of claim 16, wherein the altering a rule of game play is selected from the group consisting essentially of: preventing capture of the game pieces between the first and the second player, preventing enforcement of check rules between the first and the second player, preventing the first player from checkmating the second player and vice versa, communicating data between the first player module and the second player module through a closed channel to the exclusion of the third player module, and any combinations thereof.

18. The system of claim 12, wherein the graphical user interface further comprising instructions for displaying a fourth army associated with the plurality of substantially-squared shaped playing spaces.

19. The system of claim 18, further comprising a fourth player module in communication with the graphical user interface module and including instructions for controlling the fourth army.

20. A computer readable storage medium comprising computer readable program code for playing chess with three or more armies over a network, each army including a set of game pieces representative of game pieces of a chess game and configured to execute on a processor, the program code including instructions for:
generating a graphical user interface, according to a first mode, including:
a virtual gameboard including a plurality of substantially square-shaped playing spaces;
a first army;
a second army; and
a third army;
wherein the first army, the second army, and the third army are associated with the plurality of substantially square-shaped playing spaces;
providing control of the first army to a first player; and
providing control of the second army to a second player;
providing control of the third army to a third player;
enabling formation of an alliance among the first and second player; and
communicating data in a second mode between the first player and the second player through a closed channel to the exclusion of the third player.
